(19) United States
(12) Patent Application Publication
(10) Pub. No.: US 2007/0221581 A1
(43) Pub. Date: Sep. 27, 2007

(54) Ultrapure Water Production Plant

(75) Inventors: Katsunobu Kitami, Tokyo (JP); Ikunori Yokoi, Tokyo (JP); Masayoshi Oinuma, Tokyo (JP)

Correspondence Address: HANSEN HUANG TECHNOLOGY LAW GROUP, LLP, 1725 EYE STREET, NW, SUITE 300, WASHINGTON, DC, 20006, US

(73) Assignee: KURITA WATER INDUSTRIES LTD., Shinjuku-ku, Tokyo (JP)

(21) Appl. No.: 10/599,445

(22) PCT Filed: Mar. 30, 2005
(86) PCT No.: PCT/JP05/06028

§ 371 Date: Nov. 21, 2006

(30) Foreign Application Priority Data
Mar. 31, 2004 (JP) 2004-106438

(51) Int. Cl. C02F 1/32

(52) U.S. Cl. 210/748

(57) ABSTRACT

An ultrapure water production plant that can produce ultrapure water with an extremely low rate of impurity concentration such as dissolved oxygen concentration, etc., is provided. A primary pure water is introduced and a catalyst mixed tower 4, wherein catalyst supports strong base anion exchange resins are mixed and filled, is located in the downstream of the ultraviolet oxidation equipment of the ultrapure water production plant 1 producing ultrapure water. Further in the latter part of the catalyst mixed tower 4, membrane degasser 5 and demineralization equipment 6 are located. Hydrogen peroxide generated in the ultraviolet oxidation equipment 3 etc., is decomposed by contacting the catalyst supports filled in the catalyst mixed tower 4 and thus decomposition of the strong base anion exchange resins is inhibited. Therefore, dissolved materials from the catalyst mixed tower 4 are reduced so the quality of the water can be increased and at the same time, the load of the demineralization equipment 6 provided on the downstream can be lowered.

### TECHNICAL FIELD

The present invention relates to an ultrapure water production plant, and in particular, relates to an ultrapure water production plant by which ultrapure water whose impurity concentration, such as dissolved oxygen, is extremely low.

### BACKGROUND ART

Conventionally, an ultrapure water production plant comprising a pretreatment system, a primary pure water treatment system and a secondary pure water system (or a “subsystem”) is known. In such an ultrapure water production plant, after raw water such as industrial water is processed by the pretreatment system comprising a coagulator, etc., which in turn is processed with the primary pure water treatment system comprising demineralization equipment, etc., primary pure water is obtained. Further, a trace amount of impurities are removed from the primary pure water by the secondary pure water system, whereby ultrapure water whose resistivity is about 5 to 18 MΩ·cm is produced.

The ultrapure water being produced in this manner is used for cleaning semiconductor products; however, impurities such as organic compounds and metals contained in the ultrapure water can cause failure in semiconductor products such as pattern defects. Therefore, it is necessary to remove these impurities as much as possible. In particular, with the high integration of semiconductor products in recent years, the demand for high quality ultrapure water has increased significantly. In addition, Total Organic Carbon (TOC) concentration of the ultrapurewater is required to be less than 1 μg/L, and metal concentration is required to be less than 1 ng/L.

As it becomes difficult to control the thickness of an oxidation layer of a semiconductor products if dissolved oxygen is contained in the ultrapure water, it is also necessary to reduce as much as possible the dissolved oxygen concentration of the ultrapure water. Specifically, in recent years, the dissolved oxygen concentration of the ultrapure water is required to be less than 5 μg/L.

Accordingly, an ultrapure water production plant is proposed, where an ion exchange equipment and a membrane degasser are disposed in a latter part of an ultraviolet oxidation equipment (Japanese Patent Application Laid-open Disclosure No. H09-029,251).

The ultraviolet oxidation equipment irradiates ultraviolet rays and oxidizes and decomposes a very small amount of organic compound contained in the primary pure water. Carbon dioxide etc, generated by the oxidative degradation of the organic compounds are removed by the ion exchange equipment provided in the downstream of the ultraviolet oxidation equipment. In the ultraviolet irradiation process by the ultraviolet oxidation equipment, hydrogen peroxide and ozone may be generated due to an excess in the dose of irradiation. Hydrogen peroxide etc., that are generated by the ultraviolet oxidation equipment, is decomposed in the downstream of the ion exchange equipment which then generates oxygen, thereby increasing the concentration of dissolved oxygen.

On the other hand, the ultrapure water production plant described in Japanese Patent Application Laid-open Disclosure No. H09-029,251 provides the membrane degasser in the downstream of the ion exchange equipment. Therefore, oxygen generated by decomposing hydrogen peroxide etc. with the ion exchange equipment can be removed and thus the concentration of dissolved oxygen of the ultrapure water can be reduced.

However, hydrogen peroxide etc. dissolves ion exchange resins filled in the ion exchange equipment. Therefore, if the ion exchange equipment is provided in the downstream of the ultraviolet oxidation equipment, the ion exchange resin is dissolved and the dissolved product is eluted from the ion exchange equipment. Such eluted materials can cause a deterioration in water quality. Further, a very small amount of metal ions are eluted from the membrane degasser, which deteriorates the water quality of the ultrapure water.

Thus, it may be expected that impurity removing equipment be further provided in the downstream of the membrane degasser; however, materials which are eluted from the ion exchange equipment provided on the former step of the membrane degasser boosts the load of the impurity removing equipment provided on the latter part. If the load of the impurity removing equipment is high, the operating life of the impurity removing equipment becomes short.

When a component of the ultrapure water production plant such as the impurity removing equipment, etc. is exchanged, the operation of the ultrapure water production plant is suspended. During the suspension of the ultrapure water production plant, production of the semiconductor product is suspended. Further, upon resumption of the operation of the ultrapure water, the ultrapure water production plant needs to be started within the time range of 12 to 24 hours, because the secondary pure water system is sterilized and washed, and then liquid remaining in the ultrapure water production plant should be drained.

Therefore, ultrapure water production plants are required to be able to operate for long periods in succession; for example, one ultrapure water production plant is required to be able to operate for 3 years or longer in succession.

### DISCLOSURE OF THE INVENTION

### Problems to be Solved by the Invention

The present invention is established in the light of the above-identified problems, and its object is to provide an ultrapure water production plant, wherein eluted materials from an ion exchange equipment provided in the downstream of an ultraviolet oxidation equipment may be reduced and ultrapure water of highly purified water may be produced in succession for a long period of time.

According to an aspect of the present invention, in an ultrapure water production plant which includes at least an ultraviolet oxidation equipment and produces ultrapure water by processing primary pure water as liquid to be processed, a catalyst mixed tower, which has catalyst supports each of which has a catalyst carried on a support and anion exchange resins, is positioned in the downstream of the ultraviolet oxidation equipment.

According to the present invention, the ultraviolet oxidation equipment and the catalyst mixed tower configures a secondary pure water system of the ultrapure water production plant where ultrapure water is produced by introducing primary pure water as liquid to be processed. The primary pure water is obtained with the processing of filtrated water which has removed turbidity substance etc. by a pretreatment system, by the primary pure water treatment system. Also, the primary pure water is the liquid, whose resistivity is equal to or more than 10 MΩ·cm and where there are few impurities except for water.

The ultraviolet oxidation equipment is an equipment which includes a ultraviolet lamp and decomposes organic compounds contained in the primary pure water. For the ultraviolet lamp provided on the ultraviolet oxidation equipment, a lamp which can irradiate ultraviolet rays of approximate wavelengths of 254 nm and 185 nm is used; for instance, a low pressure mercury lamp etc. The ultraviolet ray of approximately 185 nm wavelength is preferred because its ability to decompose organic compounds is high compared with ultraviolet rays of approximately 254 nm wavelength. The structure of the ultraviolet oxidation equipment may adopt optional structures such as a batch processing type or a passing type, etc.

A catalyst mixture tower holds catalyst supports each of which has a catalyst carried on a support and anion exchange resins in the same tower. It may be considered that a catalyst tower holding only catalysts and an anion exchange tower holding only anion exchange resins are positioned sequentially in the downstream of the ultraviolet oxidation equipment. However, it is preferable to hold the anion exchange resin and the catalyst support in the same tower for simplicity of the secondary pure water system. Also, other than the catalyst supports and the anion exchange resins, the catalyst mixed tower may include for example cation exchange resins, etc.

In a catalyst mixed tower, the anion exchange resins and the catalyst supports may be held separately or held in a mixed state. If a catalyst mixed tower is provided in a so-called layered bed type where the anion exchange resins and the catalyst supports are held separately, it is preferable to locate a catalyst support layer on the inflow side of the liquid to be processed and to locate an anion exchange resin layer on its outflow side.

It is preferable that the catalyst mixed tower is configured with the mixture of the catalyst supports and the anion exchange resins where a ratio of the catalyst supports is 3 to 20 weight %, in particular to 8 to 13 weight % to the anion exchange resin. If the mixed ratio of the catalyst support is too small, the decomposition efficiency of hydrogen peroxide will drop. On the other hand, if the mixed ratio of the catalyst support is too much, materials which are eluted from the catalyst support itself will increase.

Strong base anion exchange resins are preferable for the anion exchange resins filled in the catalyst mixed tower; however week base anion exchange resins may be used. There is no special limitation for the kind of substrate to be used; for instance, styrene origins, acrylic origins, meta-acrylic origins, and phenol origins may be used. Also, there is no special limitation for the substrate structure of the anion exchange resin; a gel type, a porous type, and high porous type, etc., may be used and in particular the gel type is preferred.

For a catalyst to be carried on a support, any catalysts which can decompose hydrogen peroxide may be used without special limitation. Specifically, palladium, manganese dioxide, or ferric chloride are given. Among these, palladium alloy containing palladium is preferred because materials which are eluted from the catalyst itself are small.

For a support, which carries a catalyst, ion exchange resin, active carbon, alumina and zeolite etc., are given. In particular, a catalyst resin carrying a catalyst on an anion exchange resin as the support, which is a kind of catalyst support, is preferable because the catalyst resin is easily mixed with the anion exchange resin uniformly.

There is no special limitation in the size or form of the catalyst support; either a spherical or pellet form may be used. However, a catalyst support with a polygon form could possibly be flown out from the catalyst mixed tower and thus be a load for the latter equipment; therefore, it is preferable to use a spherical catalyst support which is carried with the ion exchange resin such as anion exchange resin, etc.

It is preferable that the liquid velocity of the liquid to be processed toward the catalyst mixed tower be set at approximately SV=10 to 200 hr⁻¹. There is no limitation for the direction of the liquid to be processed. However, there may be a difference in the specific gravity between a catalyst support and an anion exchange resin therefore it is preferable to set it to downflow to keep the mixture of both components at an appropriate state.

In the present invention, it is preferable to locate a membrane degasser in the downstream of the catalyst mixed tower and further to locate the demineralization equipment in the downstream of the membrane degasser.

For a membrane degasser, equipment, where a space where liquid to be processed is introduced (hereinafter called “a liquid room”) and a space where gas in the liquid to be processed is shifted (hereinafter called “a vacuuming room”) are formed across a degassing membrane, is used. The vacuuming room is decompressed by a vacuum pump, etc., and the gas, which is included in the liquid to be introduced in the liquid room, is shifted to the vacuuming room side via the degassing membrane and the gas in the liquid to be processed is removed.

For the degassing membrane provided in the membrane degasser, any membrane can be used as far as gases such as oxygen, nitrogen and carbon dioxide, etc., are transported across the membrane, while liquid may not be transported across the membrane. As concrete examples of the degassing membrane, there are hydrophobic macromolecule membranes, such as silicon rubber origins, tetrafluoroethylene origins, poly tetrafluoroethylene origins, poly olefine origins, and a polyurethane origins, etc. As types of the degassing membrane, there are a hollow fiber membrane type and a flat sheet membrane, etc.

As a demineralization provided in the downstream of the membrane degasser, optional ones such as electro deionization equipment or an ion exchange resin tower, etc. are used. For the ion exchange resin tower, a multilayer type tower, which has a single bed layer of ion exchange resins and a single bed layer of cation exchange resins in the same tower, may be used. Alternatively, a mixed bed type tower, which has mixed beds with a mixture of ion exchange resins and cation exchange resins, may be used. Further, demineralization equipment may be configured, connecting a single-bed ion exchange tower of ion exchange resins and a single-bed cation exchange tower of cation exchange resins in series, may be configured.

Among the above-mentioned demineralization equipments, a non-regenerated type ion exchange resin tower, which provides a mixed bed where strong acid cation exchange resins and strong base anion exchange resins are mixed, is particularly preferable because it has highly qualified ion removal ability and there are few eluted materials.

In the present invention, organic compounds are decomposed with an ultraviolet oxidation equipment, and the organic compounds included in primary pure water that is liquid to be processed is removed. Decomposition products such as carbon dioxide generated by oxidative degradation of organic compounds are absorbed and removed in the catalyst mixed tower located in the downstream of the organic-compounds oxidation equipment by anion exchange resins held within the tower. Therefore, an ultrapure water production plant according to this invention can produce highly purified ultrapure water even if the load caused by negative ion ingredients is high.

In liquids eluted from the ultraviolet oxidation equipment (hereinafter called “oxidized water”), hydrogen peroxide and ozone etc. are included. Hydrogen peroxide etc., which is included in the oxidized water, is decomposed, generates oxygen and simultaneously decomposes anion exchange resins. In the present invention, because catalyst supports are filled up with anion exchange resins in a catalyst mixed tower where oxidized water including hydrogen peroxide etc. is introduced, hydrogen peroxide etc. is decomposed by reacting preferentially with a catalyst carried in the support and the anion exchange resins are inhibited from being decomposed. Therefore, resin decomposed material, which is eluted into the liquid drained from the catalyst mixed tower (hereinafter called “mixed tower outflow water”) can be reduced.

Also in the present invention, decomposition of hydrogen peroxide etc., which is included in the oxidized water, is promoted, because catalyst supports are held in a catalyst mixed tower. Consequently, very few substances such as hydrogen peroxide remain in the catalyst mixed tower outflow water. Therefore, according to the present invention, hydrogen peroxide etc. may be prevented from remaining in the liquid that has passed through the membrane degasser provided in the downstream of the catalyst mixed tower. Hydrogen peroxide etc. is also prevented from being decomposed and generating oxygen in the downstream of the membrane degasser and a rise in the concentration of dissolved oxygen may be prevented.

Further, gasses such as oxygen generated by decomposition of hydrogen peroxide etc. in the catalyst mixed tower can be removed by locating a membrane degasser in the downstream of the catalyst mixed tower. Also, ionic substances such as metal ions eluted from the membrane degasser can be removed; thus, highly purified ultrapure water, whose metal concentration is less than 1 ng/L, can be produced.

In the former step of the membrane degasser, a catalyst mixed tower including anion exchange resins and catalyst supports is located; therefore the amount of substances eluted from the catalyst mixed tower is small and thus demineralization equipment in the downstream can be used in succession for a long period of time. Therefore, according to the present invention, highly purified ultrapure water whose impurity concentration such as dissolved oxygen and metals is extremely low, can be produced in succession for a long period of time.

### BRIEF DESCRIPTION OF THE DRAWINGS

FIG. 1 is a schematic block diagram of an ultrapure water production plant according to one embodiment of the present invention.

FIG. 2 is a figure showing results in Example 2 and Comparative example 3.

### DETAILED DESCRIPTION OF THE PREFERRED EMBODIMENTS

Next the present invention will be explained in detail with reference to the accompanying drawings.

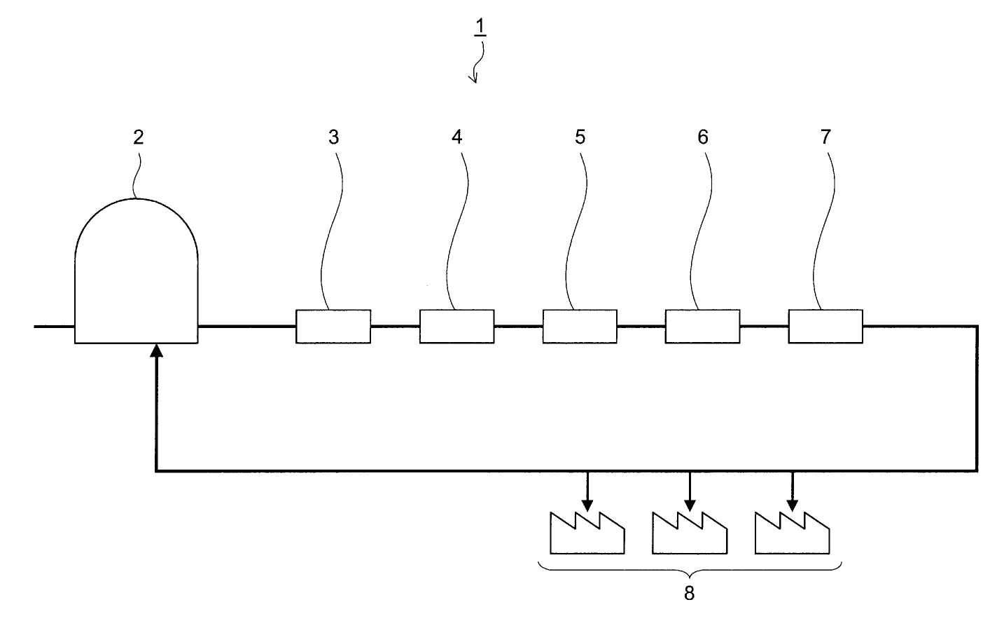

FIG. 1 is a schematic block diagram of an ultrapure water production plant 1 according to the first embodiment of the present invention. The ultrapure water production plant 1 includes a storage tank 2, an ultraviolet oxidation equipment 3, a catalyst mixed tower 4, a membrane degasser 5, demineralization equipment 6, and a membrane filtration equipment 7 comprising ultrafiltration membrane. In the storage tank 2, primary pure water being processed with a pretreatment system and a primary pure water treatment system (not shown in the figure) is stored.

The pretreatment system includes a coagulator and filtration equipment and removes parts of suspended solids and organic compounds included in raw water such as industrial water, etc. The primary pure water treatment system is a system, wherein impurities in liquid supplied from the pretreatment system (filtrated water) is removed and primary pure water, which has resistivity of equal to or more than 10 MΩ·cm, and the dissolved oxygen concentration of 0 to 1000 μg/L, organic compounds concentration of 0 to 20 μg/L, and metal concentration of 0 to 1 μg/L, is produced. The primary pure water treatment system is configured of e.g. demineralization equipment, reverse osmosis membrane filtration equipment and a degasser, etc.

The ultraviolet oxidation equipment 3, the catalyst mixed tower 4, the membrane degasser 5, demineralization equipment 6 and membrane filtration equipment 7 are collectively called a secondary pure water system or a subsystem, which introduces the primary pure water as the liquid to be processed, and produces ultrapure water by removing a very small amount of impurities included in the primary pure water.

In the present embodiment, the ultraviolet oxidation equipment 3 comprises low pressure mercury lamps (of 140 W, 10 lamps) that irradiate ultraviolet rays of approximate wavelengths of 185 nm and 254 nm.

The catalyst mixed tower 4 includes a catalyst mixed bed, in which strong base anion exchange resins are mixed with catalyst resins each of which has palladium supported on an anion exchange resin as a support. The catalyst resins are obtained by contact between anion exchange resins and an acid solution of palladium chloride. The catalyst mixed bed is configured by mixing the catalyst resins with strong base anion exchange resins, thereby making the ratio of the catalyst resins 5 to 10 weight % to the strong base anion exchange resins.

The membrane degasser 5 comprises a gas separation membrane of a polypropylene macromolecule membrane of a hollow fiber type and has a liquid room and a vacuuming room opposed via the gas separation membrane. In the membrane degasser 5, the gas included in the liquid to be processed is shifted to the vacuuming room side, setting the dissolved oxygen concentration of the liquid to be processed to less than 1 μg/L and the total dissolved oxygen gas concentration of the liquid to less than 3000 ng/L, by introducing the liquid into the liquid room and decompressing the vacuuming room.

The demineralization equipment 6 is a mixed bed ion exchange resin tower provided with a mixed bed, in which strong base cation exchange resins and strong acid anion exchange resins are mixed in the one-to-one ratio. Also in the downstream of the demineralization equipment 6, the membrane filtration equipment 7 comprising an ultrafiltration membrane is located.

The storage tank 2, the ultraviolet oxidation equipment 3, the catalyst mixed tower 4, the membrane degasser 5, and the demineralization equipment 6 and the membrane filtration equipment 7 are located in this order; and adjacent instruments are connected in series by tubes. The ultrapure water production plant 1 may include instruments other than these instruments. For example, in the former part of the ultraviolet oxidation equipment 3, a heat exchanger may be provided.

In the ultrapure water production plant 1 according to the present embodiment, primary pure water stored temporarily in the storage tank 2 is introduced from the storage tank 2 into the ultraviolet oxidation equipment 3 by a solution sending instrument such as a liquid flowing pump (not shown in the figure). In the ultraviolet oxidation equipment 3, organic compounds included in the primary pure water as liquid to be processed are decomposed and hydrogen peroxide etc. is generated. In addition, the primary pure water is sterilized by irradiation of ultraviolet rays in the ultraviolet oxidation equipment 3 and thus propagation of bacteria will be inhibited.

The liquid being processed in the ultraviolet oxidation equipment 3 is drained from the ultraviolet oxidation equipment 3 as oxidized water. The oxidized water is flown in ca. SV=10 to 200 hr⁻¹, and preferably in SV=50 to 150 hr⁻¹ in the catalyst mixed tower 4 as liquid to be processed by the catalyst mixed tower 4. The oxidized water introduced into the catalyst mixed tower 4 contacts with the catalyst resins configuring the catalyst mixed bed, hydrogen peroxide etc. is decomposed and removed, and carbonic acid ion etc. is removed by contact with strong base anion exchange resin.

The liquid being processed in the catalyst mixed tower 4 is drained from the catalyst mixed tower 4 as mixed tower outflow water and is supplied to the membrane degasser 5. The membrane degasser 5 treats the mixed tower outflow water as the liquid to be processed, and removes gases such as dissolved oxygen which is included in the mixed outflow water. Liquid obtained by the degassing process in the membrane degasser 5 (hereinafter called “degassed water”) includes a very small amount of impurities drained from the catalyst mixed tower 4 and the membrane degasser 5.

Accordingly, the degassed water is further supplied to the demineralized equipment 6 and thus dissolved ions are removed. In the present invention, the demineralization equipment 6 is a non-regenerated type ion exchange resin tower. If the absorption amount of the ion exchange resins reaches saturation point, the ion exchange resins should be exchanged.

In the present invention, because a catalyst mixed tower which includes catalyst supports and anion exchange resins is provided between the ultraviolet oxidation equipment 3 and the demineralization equipment 6, the load of the demineralization equipment 6 is low. Therefore, the demineralization equipment 6 may be miniaturized; or the exchange frequency of the ion exchange resins filled in the demineralization equipment 6 is lowered, by which a long term continuous operation for equal to or more than 3 years can be achieved.

The liquid being processed in the demineralization equipment 6 (hereinafter called “demineralized water”) is supplied to the membrane separation equipment 7, and the insoluble components such as metal fine particles which could not be removed in the demineralization equipment 6 are removed. The liquid drained from the membrane separation equipment 7 is the ultrapure water whose impurity concentration is extremely low. Thus, according to the ultrapure water production plant 1 of the present invention, ultrapure water of less than 1 μg/L in the organic carbon (TOC) concentration, less than 5 μg/L in dissolved oxygen concentration, and less than 1 ng/L in metal concentration, may be obtained with resistivity of ca. 18 to 18.25 MΩ·cm.

The ultrapure water drained from the membrane filtration equipment 7 is supplied to points of use 8, where semiconductor product cleaning equipments (not shown in the figure) etc. are provided via tubes. Also, as shown in the figure, the ultrapure water not used in the points of use 8 is circulated into the storage tank 2 via tubes. The ultrapure water production plant 1 is made to operate constantly, which accordingly prevents the ultrapure water from remaining in the tubes, prevents bacteria from multiplying, and prevents the water quality from deteriorating caused by eluting of substances such as metals etc. from the equipment-configuring members.

### EXAMPLES

### Example 1

Using the ultrapure water production plant 1 shown in FIG. 1, a primary pure water obtained by processing raw water with a pretreatment system and a primary pure water treatment system is processed as liquid to be processed, and thus produces the ultrapure water. For the pretreatment system, one in which a coagulator and a sand filter are provided, was used. Further for the primary pure water treatment system, one in which an ion exchange resin tower of 2 beds 3 towers type, a reverse osmosis membrane equipment and a vacuum degasser are provided, was used.

The quality of the raw water was: 20 mS/m in the conductivity, 700 to 1200 μg/L in the TOC concentration, 6 to 8 mg/L in the dissolved oxygen concentration, 0 to 20 mg/L in the metal concentration. The quality of the primary pure water was: 17.8 MΩ·cm in the resistivity, 1 to 5 μg/L in the TOC concentration, 10 to 50 μg/L in the dissolved oxygen concentration, 10 to 100 ng/L in the metal concentration. Also, liquid velocity toward the catalyst mixed tower 4 was set as SV=80.

### Comparative Example 1

As a substitute of the catalyst mixed tower 4 in the ultrapure water production plant 1 of FIG. 1, a mixed bed ion exchange resin tower configured from strong base anion exchange resins and strong acid cation exchange resins was located. In addition, the ultrapure water production plant was configured removing the demineralization equipment 6. In other words,

in Comparative Example 1, primary pure water was flown in an order of an ultraviolet oxidation equipment, a mixed bed ion exchange resin tower, a membrane degasser, and an ultrafiltration membrane equipment; and thus, ultrapure water was produced.

The mixed bed ion exchange resin tower has a configuration which is the same as Example 1 but does not include the catalyst resins. The configuration of the ultraviolet oxidation equipment, the membrane degasser and the ultrafiltration membrane equipment were the same as in Example 1.

### Comparative Example 2

As Comparative Example 2, another ion exchange equipment, which is the same as the ion exchange equipment used in Example 1, was located in the downstream of the membrane degasser of the ultrapure water production plant in the Comparative Example 1. In other words, in Comparative Example 2, primary pure water was flown in an order of the ultraviolet oxidation equipment, the mixed bed ion exchange resin tower, the membrane degasser, a mixed bed ion exchange resin tower and the ultrafiltration membrane equipment; and thus, ultrapure water was produced.

In Table 1, hydrogen peroxide concentrations in the liquid collected in the exits of each plant in the example and the comparative examples are shown. In the following table, “UV” refers to an ultraviolet oxidation equipment; “ADI” represents a catalyst mixed tower; “MD” represents a membrane degasser; “DI1” represents a mixed bed ion exchange resin tower; “DI2” represents a mixed bed ion exchange resin tower; and “UF” represents ultrafiltration membrane equipment. Also, the numerical value unit is entirely set as μg/L except for metal concentration.

TABLE 1

| | Primary pure | UV | ADI exit | MD | | |
|---|---|---|---|---|---|---|
| | water | exit | DI1 exit | exit | DI2 exit | UF exit |
| Example | <1 | 12 | 4 | 1 | <1 | <1 |
| Comparative | <1 | 12 | 6 | 6 | — | 6 |
| Example 1 | | | | | | |
| Comparative | <1 | 12 | 6 | 6 | 5 | 5 |
| Example 2 | | | | | | |

In Table 2, dissolved oxygen concentration in the liquid collected in the exits of each plant in the example and the comparative examples are shown.

TABLE 2

| | Primary pure | UV | ADI exit | MD | DI2 | |
|---|---|---|---|---|---|---|
| | water | exit | DI1 exit | exit | exit | UF exit |
| Example | 10 | 10 | 12 | <1 | <1 | <1 |
| Comparative | 10 | 10 | 15 | <1 | — | <1 |
| Example 1 | | | | | | |
| Comparative | 10 | 10 | 15 | <1 | 2 | 2 |
| Example 2 | | | | | | |

In Table 3, TOC concentration in the liquid collected in the exits of each plant in the example and the comparative examples are shown.

TABLE 3

| | Primary pure | UV | ADI exit | MD | | |
|---|---|---|---|---|---|---|
| | water | exit | DI1 exit | exit | DI2 exit | UF exit |
| Example | 3.0 | 2.0 | <1 | <1 | <1 | <1 |
| Comparative | 3.0 | 2.0 | <1 | 1.5 | — | 1.5 |
| Example 1 | | | | | | |
| Comparative | 3.0 | 2.0 | <1 | 1.5 | <1 | <1 |
| Example 2 | | | | | | |

In Table 4 metal (Fe) concentration in the liquid collected in the exits of each plant in the example and the comparative examples are shown. In the Table 4, the numerical value unit is set as ng/L.

TABLE 4

| | Primary pure | UV | ADI exit | MD | | |
|---|---|---|---|---|---|---|
| | water | exit | DI1 exit | exit | DI2 exit | UF exit |
| Example | 3 | 4 | 4 | 4 | <1 | <1 |
| Comparative | 3 | 4 | <1 | 2 | — | 2 |
| Example 1 | | | | | | |
| Comparative | 3 | 4 | <1 | 2 | <1 | <1 |
| Example 2 | | | | | | |

As shown in Table 1 to 4, in the comparative examples, the dissolved oxygen concentration of the water at the ultrafiltration membrane exit (ultrapure water), the TOC concentration, and the metal concentration was high. In the example, on the other hand, the hydrogen peroxide concentration, the dissolved oxygen concentration, and the TOC concentration were all less than 1 μg/L. The metal concentration was less than 1 ng/L, thus ultrapure water of highly purified water could be produced.

### Example 2

As Example 2, an examination was performed, changing the liquid velocity of liquid to be processed, which is flown in the catalyst mixed tower 4 using ultrapure water production plant 1 shown in FIG. 1 the same as in Example 1. Specifically, while liquid velocity toward the catalyst mixed tower 4 is set as SV=80 in Example 1, SV=53 was set in Example 2. In addition, while hydrogen peroxide concentration of the liquid which flowed out from the exit of the ultraviolet oxidation equipment 3 and supplied into the catalyst mixed tower 4 was 12 μg/L as shown in Table 1 in Example 1, the concentration was 29 μg/L in Example 2.

### Comparative Example 3

Instead of the catalyst mixed tower 4, by using a catalyst tower where strong base anion exchange resins were not included and only the catalyst resins were filled up, an examination was performed in which the liquid to be processed was passed through the catalyst tower changing the liquid velocity. Hydrogen peroxide concentration of the liquid from the ultraviolet oxidation equipment 3 exit was 29 μg/L same as Example 2.

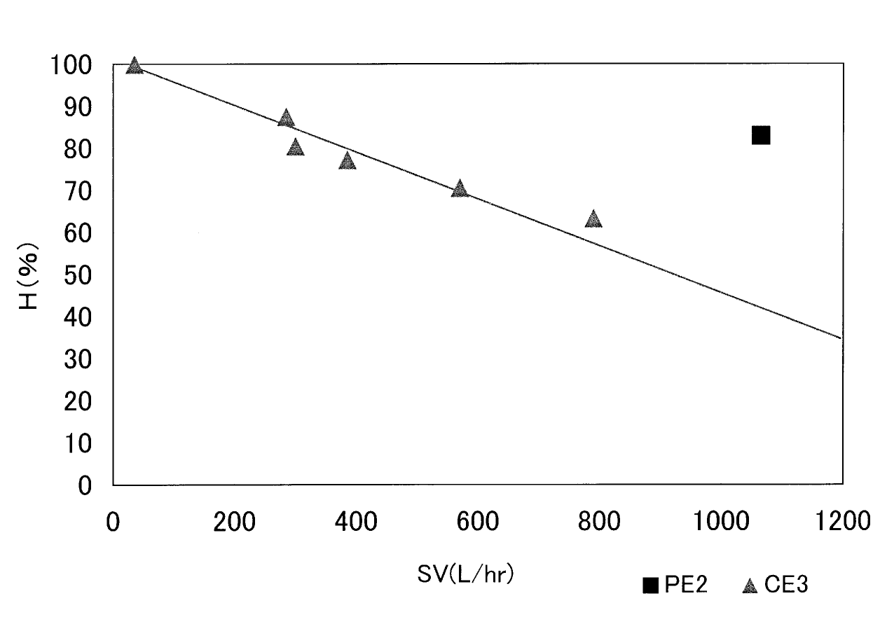

Results of Example 2 and Comparative Example 3 are shown in FIG. 2. In FIG. 2, the vertical axis shows the decomposition rate of hydrogen peroxide (%) calculated from the hydrogen peroxide concentration of the liquid in the exit of the catalyst mixed tower 4, to the hydrogen peroxide concentration of the liquid in the exit of the ultraviolet oxidation equipment 3; and cross axis shows the liquid velocity (SV) to the catalyst resins. In FIG. 2, the decomposition rate of the hydrogen peroxide (%) is shown with a symbol H and the result of Example 2 illustrated with a square point shown with a symbol PE2 and the results of Comparative Example 3 are illustrated with a triangle point shown with a symbol CE3. In Example 2, anion exchange resins and the catalyst resin were filled up in the catalyst mixed tower 4 and the rate of the catalyst resins was 5 weight % for the anion exchange resins. Therefore, the liquid velocity to the catalyst resin was SV=1065.

In Comparative Example 3, in which a process was conducted solely with the catalyst resins, it was shown that the decomposition rate of the hydrogen peroxide deteriorated as the liquid velocity increased, and the relationship between the decomposition rate of hydrogen peroxide and the liquid velocity was in alignment shown in FIG. 2. On the other hand, it was shown that the result of Example 2 being processed in the mixed bed of catalyst resins and anion exchange resins was much higher than the decomposition rate of hydrogen peroxide assumed from a straight line lead from the examination result of Comparative Example 3

The present invention may be applied to ultrapure water production plants used in the production of semiconductor products such as LSIs, wafers, etc., or production of medical supplies.

1. An ultrapure water production plant producing ultrapure water by introducing primary pure water as liquid to be processed, comprising:
an ultraviolet oxidation equipment; and
a catalyst mixed tower located in the downstream of the ultraviolet oxidation equipment and having catalyst supports each of which has a catalyst carried on a support, and anion exchange resins.

2. The ultrapure water production plant according to claim 1, wherein a membrane degasser and a demineralization equipment are located in the downstream of the catalyst mixed tower.

3. The ultrapure water production plant claimed in claim 2, wherein the demineralization equipment is an ion exchange resin tower comprising a mixed bed in which the anion exchange resins and cation exchange resins are mixed.
